(19) United States
(12) Patent Application Publication
(10) Pub. No.: US 2025/0291640 A1
(43) Pub. Date: Sep. 18, 2025

(54) DETECTION AND EXTENSION OF PROXIMATE COMPUTE

(71) Applicant: Microsoft Technology Licensing, LLC, Redmond, WA (US)

(72) Inventors: Nagraj GOPALAKRISHNAN, Hyderabad (IN); Shubham KUMAR, Hyderabad (IN); David B. PERRY, Redmond, WA (US); Shilpa Satyen LULLA, Hyderabad (IN); Mallikarjuna Rao VOLETI, Bengaluru (IN)

(21) Appl. No.: 18/602,209

(22) Filed: Mar. 12, 2024

(51) Int. Cl. G06F 9/50

(52) U.S. Cl. CPC G06F 9/5055; G06F 9/5044; G06F 2209/503

(57) ABSTRACT

The technology disclosed herein provides a method of detecting proximate devices and extending a resource-intensive AI task to one of the proximate devices, the method including determining that a compute task on a primary device is a resource-intensive AI task requiring one or more resources above a threshold, determining that the resource-intensive AI task can be delegated to one or more proximate computing devices, scanning one or more proximate devices to receive device advertisement packets, determining weighted scores for the one or more proximate devices based on the advertisement packets, selecting one of the one or more proximate devices based on the weighted scores, and communicating a compute task delegation request to the selected proximate device.

### BACKGROUND

Use of artificial intelligence (AI) is exponentially increasing. AI models require extensive compute resources that may be not generally available on a single computing device. For example, AI models such as large language models (LLMs), generative AI models, etc., require a large number of resources, including storage resources, compute resources, etc. AI models are increasingly being run on local computers to augment cloud computing and handle AI requests where cloud model is not appropriate or not available. However, when one or more of such AI models are deployed proximate to the end user on the user's computing device, such computing devices may be resource constrained to efficiently execute various processes of the AI Models.

### SUMMARY

The technology disclosed herein provides a system and method for offloading one or more processes of an AI model being run on a main local computing device to other appropriate devices in proximity to the main local computing device. For example, the main local computing device may be a user's laptop and the other appropriate devices in proximity may include another laptop, a tablet, a mobile device, etc

Specifically method of detecting proximate devices and extending a resource-intensive AI task to one of the proximate devices as disclosed herein includes determining that a compute task on a primary device is a resource-intensive AI task requiring one or more resources above a threshold, determining that the resource-intensive AI task can be delegated to one or more proximate computing devices, scanning one or more proximate devices to receive device advertisement packets, determining weighted scores for the one or more proximate devices based on the advertisement packets, selecting one of the one or more proximate devices based on the weighted scores, and communicating a compute task delegation request to the selected proximate device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following, more particular written Detailed Description of various implementations as further illustrated in the accompanying drawings and defined in the appended claims.

Other implementations are also described and recited herein.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example system that facilitates smart and seamless detection and extension of proximate compute.

FIG. 2 illustrates example sequence of communications between various components of the system for detection and extension of proximate compute.

FIG. 3 illustrates example operations of the system disclosed herein for providing detection and extension of proximate compute.

FIG. 4 illustrates alternative example operations for providing detection and extension of proximate compute.

FIG. 5 illustrates an example schematic of a processing device suitable for implementing aspects of the disclosed technology.

### DETAILED DESCRIPTION

Artificial Intelligence (AI) generally involves simulation of human intelligence processes by machines, especially computer systems. Specific applications of AI may include, for example, expert systems, natural language processing, speech recognition, generative AI, machine vision, etc. AI models are increasingly being run on local computers to augment cloud computing and handle AI requests where cloud model is not appropriate or not available. However, such AI models require extensive computational power that is typically not available on one local computing devices, such as a laptop, a desktop, a tablet, a mobile phone, etc.

Running an AI models may involve a number of AI tasks or machine learning (ML) tasks. For example, an AI model for natural language processing (NLP) may include a text classification task, a named entity recognition (NER) task, a relation extraction (RE) task, a text generation task, etc. Similarly, an AI model for image recognition may include an object localization task, an image segmentation task, image filtering task, etc. On the other hand, an AI model for data classification may include various tasks such as classification, regression, clustering, anomaly detection, data visualization, dimensionality reduction, content generation, etc. One or more of such tasks of AI models, referred to herein as AI tasks, may be run on a primary device running the AI model. Alternatively, a server may delegate one or more of such AI tasks to a primary device.

Some of the AI tasks being performed on the primary device may be resource intensive AI tasks in that they may require intensive use of one or more resources. For example, a data classification task may be a resource-intensive AI task if it requires a number of operations per second (OPS) that exceeds a threshold. Similarly, an image filtering task may be a resource-intensive AI task if it consumes (renders unavailable) a quantity of cache resources in excess of a threshold cache quantity.

The technology disclosed herein provides a system and method for offloading one or more AI tasks that are generally configured to run on a main local computing device to other appropriate devices in proximity to the main local computing device. For example, the main local computing device may be a user's laptop and the other appropriate devices in proximity may include another laptop, a tablet, a mobile device, etc. Specifically, the technology disclosed herein provides intelligent decision making algorithms to identify required computational power to execute high-compute AI models among the user's personal device and trusted proximate devices. Subsequently, the algorithm determines when to use the local computer for the AI task and when the AI task needs to be transferred to a proximate device.

Herein, the proximate compute devices may include smart devices including personal computers, laptops, mobile devices, tablets, etc., that are available in proximity to the primary device executing the resource-intensive AI task. For example, the proximate devices may be local client devices associated with the user of a primary device. In one implementation, the primary device and the local devices associated with the user are configured to collectively execute all of the resource-intensive AI tasks. For example, a host or a server may send an AI process to the primary device and the primary device, after identifying one or more resource-intensive AI tasks and determining one or more proximate devices that are associated with the user, executes the entire AI process by either executing such resource-intensive AI tasks on the primary device or by offloading them to the one or more proximate devices that are associated with the user.

Alternatively, such proximate devices need not be connected to the same user network. For example, some of such proximate devices maybe connected to the primary device via a Bluetooth low energy (BLE) network, whereas other proximate devices may be connected to the primary device via an ultra-wideband (UWB) network, a wi-fi direct communication network, etc.

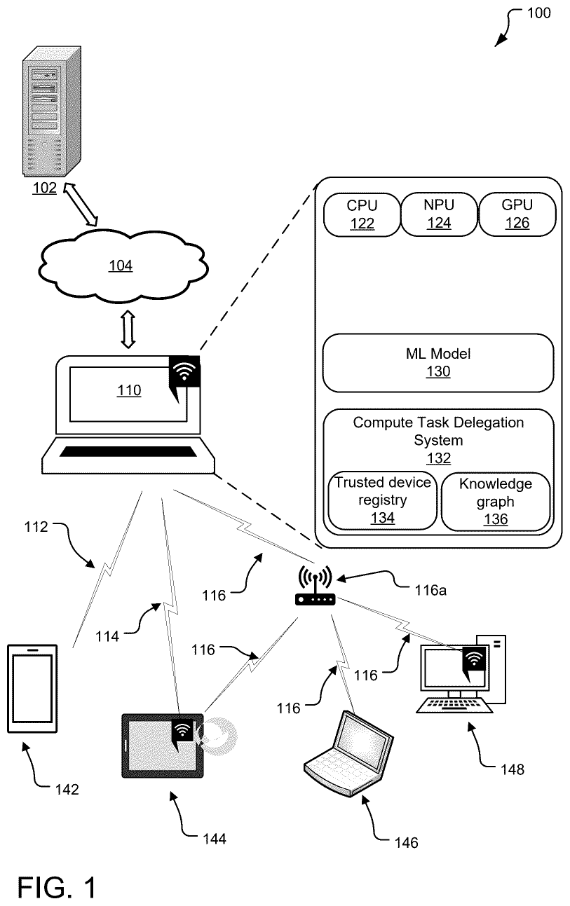

FIG. 1 illustrates a system 100 that facilitates smart and seamless detection and extension of proximate compute. Specifically, the system 100 includes a primary device 110 that may be communicatively connected to a server 102 via a network 104 such as the Internet. The primary device 110 may be a laptop, a desktop, or another smart device that is configured to execute various applications including AI models. The primary device 110 may be communicatively connected to various other devices such as a mobile device 142, a tablet 144, a laptop 146, a PC 148, etc. One or more of these devices 142-148 maybe proximate to the primary device 110 in that they may be communicatively connected to the primary device 110 via a high-speed close communication network such as a Bluetooth low energy (BLE) network 112, an ultra-wideband (UWB) network 114, a wi-fi direct communication network 116 using a wi-fi router 116a, etc.

The primary device 110 may include one or more processing units such as a central processing unit 122, a neural processing unit 124, a graphical processing unit 126, etc. Also, the primary device 110 may include memory that stores various data and computer instructions for various applications. One or more such applications running on the primary device 110 may execute resource-intensive AI tasks that require utilization of one or more resources at a high level. For example, a data visualization AI task may require use of cache memory above a threshold percentages at a high level, such as at or above 90% of the cache memory available on the primary device. As another example, an anomaly detection AI task may require use of OPS on the primary device at a high level such that for an extended period of time the primary device is not able to execute other processes efficiently.

Alternatively, the server 102 may delegate a resource-intensive AI task to the primary device 110. An example of an application that runs on the primary device 110 and that executes a resource-intensive AI task is a machine learning (ML) model 130. One example of a resource-intensive AI task performed by the ML model 130 is a task that requires a resource that is higher than a resource threshold. Such resource threshold may be based on a capacity of the primary device 110, such as the number of tera-ops per second (TOPS) that can be handled by a processor of the primary device 110, the cache available to the primary device 110, the amount of power available to the primary device, etc. For example, the primary device 110 may set the resource threshold for power level based on current power level available and usage rate of the power by other processes running on the primary device 110.

Similarly, a resource-intensive AI task may be a task that utilizes a quantity of memory in excess of a resource threshold for memory. For example, the primary device may set the resource threshold for memory utilization to be at 50% of available cache memory for its processor. In such an example, if the available cache is 200 MB, an AI task that requires use of more than 100 MB is determined to be a resource-intensive AT task. While the above examples provide resource thresholds based on memory, OPS, power level, etc., other resource thresholds based on other operating parameters of the primary device 110 may be used to determine if an AI task is a resource-intensive AI task. Examples of such other parameters of the primary device 110 may include a communication bandwidth available to the primary device, current operating temperature of the primary device 110, etc.

An example of such a resource-intensive AI task is an AI task that requires more than a predetermined quantity of TOPS to be performed by a processor of the primary device. As an example, a regression task may be a resource-intensive AI task if it requires TOPS to be performed by a processor that is over 95% of the TOPS that the processor is capable of performing. Another example of a resource-intensive AI task is an image processing ML task that requires utilization of a quantity of cache memory in excess of a predetermined number of mega-bytes (MBs).

For example, an application running on the primary device 110 may be an AI application that requires use of processing power above a threshold level of operations per second. An example of such an application is an AI application that allows a user to submit a request in a text form, such as “find Jane Doe's picture at her office in Denver,” and in response perform a large number of image processing AI tasks that analyze an image data store on the primary device 110.

In an implementation disclosed herein, the primary device 110 may have a compute task delegation system 132 stored in memory thereof. The compute task delegation system 132 may evaluate the image processing AI tasks and determine that one of these AI tasks is a resource-intensive AI task in that it requires one or more resources above a threshold. For example, the compute task delegation system 132 may determine that an AI task needs large number of operations per second (OPS) and that it would be more efficient to delegate such task to a proximate device.

In response to such determination, the compute task delegation system 132 may initiate scanning various proximate devices 142-148 on a user network over the communication networks 112-116. Specifically, such scanning of the proximate devices 142-148 may involve obtaining device advertisement packets from the proximate devices 142-148. One or more of these proximate devices 142-148 may include NPUs, GPUs, CPUs, etc., and the device advertisement packets from these proximate devices 142-148 may include information about the resources available at such proximate devices 142-148. Example information in the device advertisement packets may include device identifiers, device configuration specification, TOPS available in a given timeframe, cache availability level indicating available cache memory, device power availability level including battery level, etc.

In one implementation one or more of such proximate devices 142-148 may have previously worked with the primary device 110 in executing a compute task delegated by the primary device 110. In such case, the proximate device may also send the performance pattern for previously executed tasks as part of the device advertisement packet. For example, the laptop 146 may have previously completed an image processing AI task delegated thereto by the primary device 110. In that case, the laptop 146 may include performance patterns for such previous image processing AI task such as the number of TOPS required to complete the image processing AI task, the total time taken to complete the image processing AI task, cache used to complete the image processing AI task, etc.

The compute task delegation system 132 analyzes the information from the various device advertisement packets. In one implementation, the compute task delegation system 132 may include a trusted device registry 134 that stores device identifiers for various proximate devices that are trusted for delegation of resource-intensive AI tasks by the primary device 110. The trusted device registry 134 may be developed over a predetermined time-period based on the device advertisement packets received from the proximate devices. For example, based on the device identifier and the network its connected to, the compute task delegation system 132 may have determined that the mobile device 142 belongs to a family, friend, or a colleague of the user of the primary device 110 and therefore it is a trusted device for delegating a resource-intensive AI task.

In such as case, the compute task delegation system 132 may add the device identifier of the mobile device 142 to the trusted device registry 134 and send a request to the mobile device 142 to become a trusted device. Such request to the mobile device 142 may be for making the mobile device 142 a permanently trusted device or a transiently trusted device. Determining if the mobile device 142 is to be a permanently trusted device or a transiently trusted device may be based on whether the mobile device 142 uses the same user identity as the primary device, whether the mobile device 142 is registered to as a trusted family device, etc.

Furthermore, the compute task delegation system 132 may also build and store a task delegation knowledge graph 136 about the usage and performance patterns of the proximate devices 142-148. The task delegation knowledge graph 136 may include information about trust levels of the proximate devices 142-148, their performance levels during past tasks, their general device resource availability levels, device power availability level, device operations per second (OPS) level, cache availability levels, etc. The information stored in the task delegation knowledge graph 136 maybe used to create and maintain reliability ratings for the proximate devices 142-148.

The compute task delegation system 132 uses the information received as part of the device advertisement packets to generate a weighted score for each of the proximate devices 142-148 that are candidate for delegation of a resource-intensive AI task. For example, the compute task delegation system 132 may give the TOPS available a weight of 50%, the cache available level a weight of 25%, and reliability rating a weight of 10% in determining weighted scores for each of the various proximate devices. In one implementation, the weights allocated to the various parameters may depend on the resource-intensive AI task to be delegated. For example, for a resource-intensive AI task that pertains to sensitive data for the user of the primary device 110, the weight allocated to the reliability may be higher. On the other hand, for a resource-intensive AI task that is time sensitive for the user of the primary device 110, the weight allocated to the TOPS available may be higher.

Once the weighted scores for each of the proximate devices are calculated, the compute task delegation system 132 selects a proximate device based on the weighted scores. Subsequently, the compute task delegation system 132 may communicate a compute task delegation request to the selected proximate device. For example, if the weighted score of the PC 148 is higher than that of the other proximate devices 142-146, the compute task delegation system 132 communicates a compute task delegation request to the PC 148 over the wi-fi direct communication network 116. Subsequently, the PC 148 may communicate an acknowledgement to the primary device and upon receipt of the acknowledgement, the compute task delegation system 132 may delegate a resource-intensive AI task to the PC 148.

The proximate devices 142-148 may be local client devices associated with the user of a primary device 110. In one implementation, the primary device 110 and the proximate devices 142-148 associated with the user are configured to collectively execute all of the resource-intensive AI tasks. For example, the host or a server 102 may send an AI process to the primary device 110 and the primary device 100, after identifying one or more resource-intensive AI tasks and determining one or more proximate devices 142-148 that are associated with the user, executes the entire AI process by either executing such resource-intensive AI tasks on the primary device 110 or by offloading them to the one or more proximate devices 142-148 that are associated with the user.

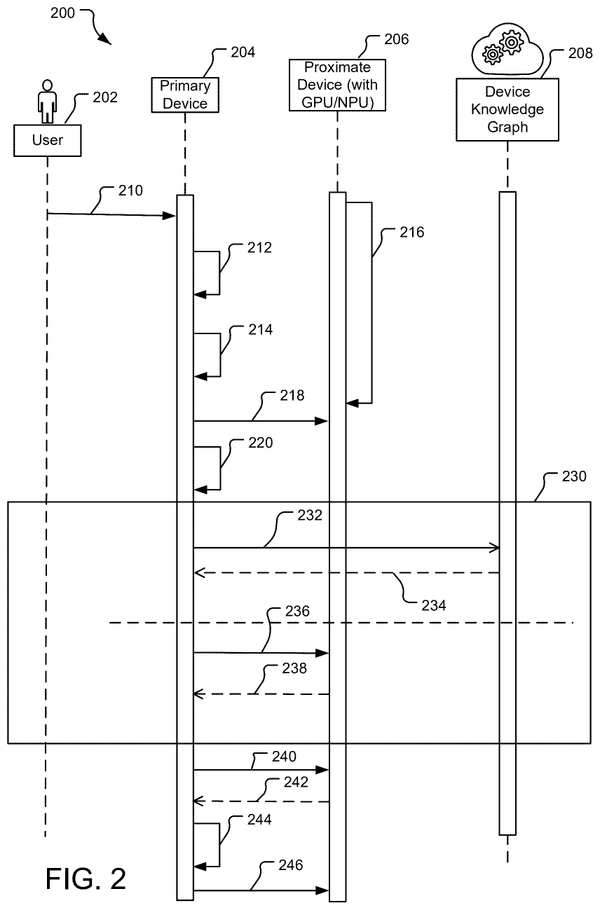

FIG. 2 illustrates a sequence of communications 200 between various components of the system for detection and extension of proximate compute. Specifically, the sequence of communications 200 allows the detection of proximate computing devices that may be capable of executing one or more resource-intensive AI tasks and offloading such resource-intensive AI tasks thereto. At 210, a user 202 may request a primary device 204 to perform a resource-intensive AI task, such as an AI or an ML task. For example, the user may provide a prompt to the primary device 204 that triggers a generative AI task. In response, at 212, the primary device 204 may analyze the task to determine that it is a resource-intensive AI task that requires a resource above a threshold. Alternatively, the primary device 204 may also determine the task to be a resource-intensive AI task if it determines use of a specialized processing unit such as a GPU, an NPU, etc.

In response to determining that the task is a resource-intensive AI task, at 216 the primary device 204 may start scanning devices in proximity thereto to see if there is any proximate device available that has a GPU or an NPU or that any such proximate device is capable of executing the resource-intensive AI task. For example, the primary device 204 may perform such scanning of the proximate devices among the devices that are connected to the primary device 204 by trusted local communication network such as BLE, wi-fi direct, etc.

One or more of the proximate devices, such as a proximate device 206 may be configured to communicate advertisement packets at 216 where the advertisement packets include information about such proximate device 206 including its processing units (GPU, NPU, etc.), its available processing power, its identifier, etc. In one implementation, the proximate device 206 may be configured to communicate such advertisement packets over the local network perpetually, at predetermined time intervals. At operation 218, the primary device 204 listens to an advertisement packet from the proximate device 206. Once the existence of the proximate device 206 is determined based on the advertisement packet, at 220, the primary device 204 identifies a resource-intensive AI task that may be offloaded to the proximate device 206.

In one implementation, the primary device 204 may execute various operations 230 continuously over a loop until a proximate device, such as the proximate device 206 accepts a resource-intensive AI task. Specifically, at 232, the primary device 204 validates if a proximate device, such as the proximate device 206 belongs to the user 202 of the primary device 204 or that it is a trusted device in the network of the user 202. Specifically, the primary device 204 may perform such validation by inquiring a device knowledge graph 208 using the device identifier that may be received from the proximate device 206 as part of the advertisement packet. At 234, the device knowledge graph 208 may send a confirmation that the proximate device 206 belongs to the same user 202 or that it is a trusted device in the network of the user 202.

In response to receiving the confirmation of the proximate device 206 being a trusted device, at 236, the primary device 204 communicates a pairing request to the proximate device 206. For example, such pairing request may be a transient pairing request or a permanent pairing request. In one implementation, the type of pairing request may be determined based on availability of devices matching a compute criterion of the primary devices 204. Alternatively, in one implementation, the type of request may be based on the user of the proximate device 206. For example, if the user of the proximate device 206 is the same as the user of the primary device 204, the pairing request may be a permanent pairing request. On the other hand, if the user of the proximate device 206 is a colleague of the user or the primary device 204, only a transient pairing request may be sent. In response, the proximate device 206 accepts the pairing request at 238 to complete the pairing of the proximate device 206 as a trusted device with the primary device 204.

After the pairing of the proximate device 206, at 240, the primary device 204 offloads the resource-intensive AI task to the paired proximate device 206. Such offloading of the resource-intensive AI task may involve communicating device identifier, input arguments, etc., to the proximate device 206. Upon completion of the resource-intensive AI task, at 242 the proximate device 206 communicates the results of the resource-intensive AI task to the primary device 204. The primary device 204 may analyze the results and various parameters thereof, such as the time taken to complete the task, etc., and provide feedback to a knowledge graph engine at 244. For example, such knowledge graph engine may also update the device knowledge graph. Subsequently at 246, the primary device 204 communicates with the proximate device 206 to update the reliability ratings of the proximate device 206.

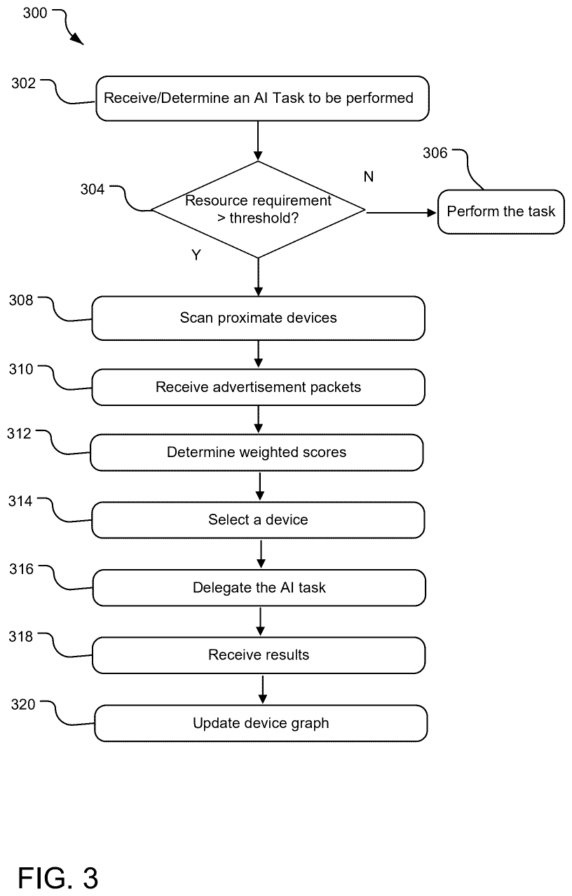

FIG. 3 illustrates operations 300 of the system disclosed herein for providing detection and extension of proximate compute. Specifically, an operation 302 may receive an AI task or determine that an AI task is to be performed. For example, a server may offload an AI task to a primary computing device or alternatively a user request at the primary device may trigger an AI task. Subsequently, an operation 304 determines if one or more resources required by the AI task are above a threshold. For example, if the primary device has only a first number of TOPS available for a time period and the AI task requires higher TOPS, the operation 304 may determine it to be a resource-intensive AI task.

If the AI task is not a resource-intensive AI task, the primary device may perform the AI task at 306 without any offloading of the AI task. However, if the operation 304 determines that the AI task is a resource-intensive AI task requiring one or more resources above a threshold, an operation 308 scans proximate devices. In one implementation, scanning the proximate devices may include scanning devices that are connected to the primary device over a trusted local communication network such as a BLE communication network, an ultra-wideband (UWB) network, a wi-fi direct communication network, etc. The proximate devices may include smart devices such as mobile devices, tablets, laptops, PCs, etc., with processing power provided by GPUs, NPUs, etc.

An operation 310 receives advertisements packets from the proximate devices. The advertisement packets from the proximate devices may include proximate device identifier, proximate device resource availability levels, past performance matrix for the proximate device, etc. An operation 310 collects the advertisement packets from various proximate devices and calculates weighted scores for each of the one or more proximate devices. For example, the weighted score for a given proximate device may be determined by giving different weights to different operational parameters received from the proximate device. Furthermore, the operation 312 may also use information from a device knowledge graph, such as device reliability rating and its assigned weight to calculate the weighted score for the proximate device.

In one implementation, the weights allocated to each of the various operational parameters of the proximate devices may depend on the resource-intensive AI task that needs to be offloaded from the primary device. For example, if such resource-intensive AI task is related to processing of secure information, the trust level or the reliability level of the proximate device may be given higher weight. Alternatively, if the resource-intensive AI task is time-sensitive, in that it needs to be completed in short period of time, higher weight may be given to the TOPS available at the proximate device.

Subsequently, an operation 314 selects one of the proximate devices for delegating the resource-intensive AI task. For example, such selection may be based on the weighted scores of the proximate devices as calculated at operation 314. An operation 316 delegates the resource-intensive AI task to the selected proximate device. Subsequently, an operation 318 may receive the results of the resource-intensive AI task from the proximate device. The results may also include other operational parameters associated with the completion of the resource-intensive AI task. Examples of such operational parameters may include the time taken to complete the resource-intensive AI task, the memory resources utilized in completing the resource-intensive AI task, the battery power used in completing the resource-intensive AI task, etc. An operation 320 updates a device graph based on the results. For example, updating of the device graph may include updating reliability rating of the proximate device that completed the offloaded resource-intensive AI task.

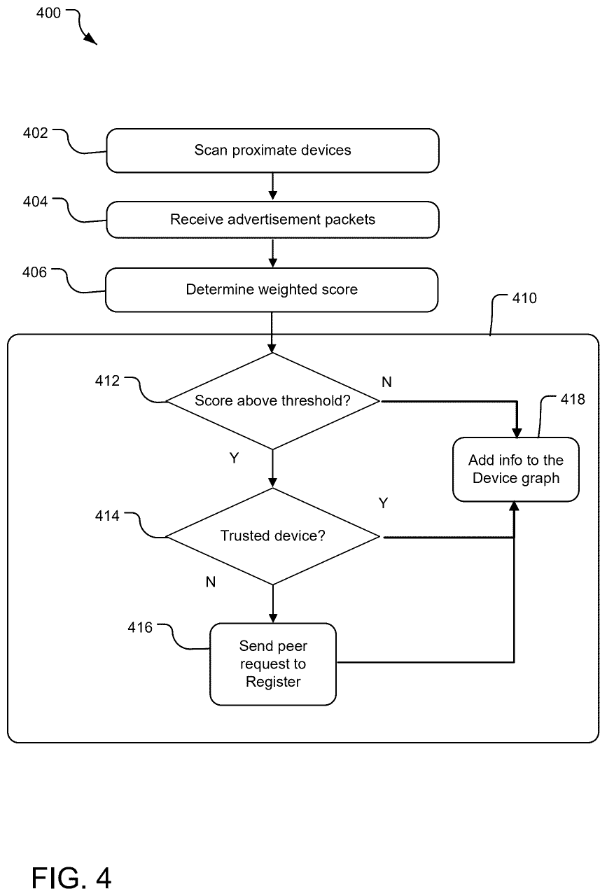

FIG. 4 illustrates alternative operations 400 for providing detection and extension of proximate compute. Specifically, the operations 400 allow a primary device to generate and maintain a device graph with information about reliability and past performance of one or more proximate devices. Such device graph may be used in selection of proximate devices for offloading one or more resource-intensive AI tasks.

An operation 402 scans proximate device, where the proximate devices may be communicatively connected to the primary device over a local and trusted communication network. An operation 404 receives advertisement packets from the various proximate devices and the information received in the advertisement packets may be used by an operation 406 to determine weighted scores for the proximate devices.

For each of the proximate devices, an operation 412 determines if the weighted score for the proximate device is above a threshold or not. If the weighted score is above a threshold, an operation 414 determines if the proximate device is a trusted device. For example, determining if a proximate device is a trusted device may include analyzing its identifier to determine if it is owned by the user, a family member of the user, a colleague of the user, etc. Alternatively, determining if a proximate device is a trusted device may include determining if the proximate device is on a trusted local communication network of the primary device.

If the proximate device is a trusted device, an operation 416 sends a peer request to the proximate device to register with the primary device as a trusted device. The operations 400 are used to build and maintain a device graph for the primary device and therefore, after each of the operations 412 to 416, an operation 418 updates a device graph with the results of the operations 412 to 416. As illustrated herein, the operations 410 may be performed for each of the proximate devices to update the device graph.

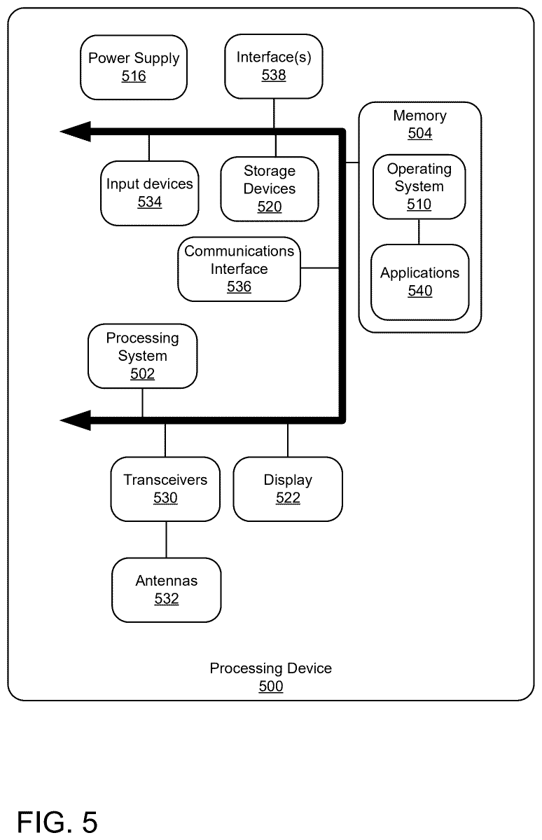

FIG. 5 illustrates an example schematic of a processing device 500 suitable for implementing aspects of the disclosed technology. The processing device 500 includes a processing system 502, memory device(s) 504, a display 522, and other interfaces 538 (e.g., buttons). The processor system(s) 502 may each include one or more computer processing units (CPUs), graphics processing units (GPUs), etc.

The memory 504 generally includes both volatile memory (e.g., random access memory (RAM)) and non-volatile memory (e.g., flash memory). An operating system 510, such as the Microsoft Windows® operating system, the Microsoft Windows® Phone operating system or a specific operating system designed for a gaming device, may reside in the memory 504 and be executed by the processing system 502, although it should be understood that other operating systems may be employed. The memory 504 may be a physically manufactured computer readable storage medium.

One or more applications 540 (e.g., the compute task delegation system 132) are loaded in the memory 504 and executed on the operating system 510 by the processing system 502. In some implementations, aspects of the delegated authenticator 214 are loaded into memory of different processing devices connected across a network. The applications 540 may receive inputs from one another as well as from various input local devices 534 such as a microphone, input accessory (e.g., keypad, mouse, stylus, touchpad, gamepad, racing wheel, joystick), or a camera. A communication interface 536 may allow the processing device 500 to communicate with other devices or network, such as the Internet.

Additionally, the applications 540 may receive input from one or more remote devices, such as remotely located servers or smart devices, by communicating with such devices over a wired or wireless network using more communication transceivers 530 and an antenna 532 to provide network connectivity (e.g., a mobile phone network, Wi-Fi®, Bluetooth®). The processing device 500 may also include one or more storage devices 520 (e.g., non-volatile storage). Other configurations may also be employed. In one implementation, the delegated authenticator 214 is an application executing on the processing device 500 or as a distributed application with different components executing on many different devices.

The processing device 500 further includes a power supply 516, which is powered by one or more batteries or other power sources, and which provides power to other components of the processing device 500. The power supply 516 may also be connected to an external power source (not shown) that overrides or recharges the built-in batteries or other power sources.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes RAM, read-only memory (ROM), electrically erasable programmable read-only memory (EEPROM), flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, radio frequency (RF), infrared and other wireless media.

A method disclosed herein includes determining that a compute task on a primary device is a resource-intensive AI task requiring one or more resources above a threshold, determining that the resource-intensive AI task can be delegated to one or more proximate computing devices, scanning one or more proximate devices to receive device advertisement packets, determining weighted scores for the one or more proximate devices based on the device advertisement packets, selecting one of the one or more proximate devices based on the weighted scores, and communicating a compute task delegation request to the selected proximate device.

A system disclosed herein includes memory, one or more processor units, and a compute task delegation system stored in the memory and executable by the one or more processor units, the compute task delegation system encoding computer-executable instructions on the memory for executing on the one or more processor units a computer process, the computer process including determining that a compute task on a primary device is a resource-intensive AI task requiring one or more resources above a threshold, determining that the resource-intensive AI task can be delegated to one or more proximate computing devices, scanning one or more proximate devices to receive device advertisement packets, determining weighted scores for the one or more proximate devices based on the device advertisement packets, selecting one of the one or more proximate devices based on the weighted scores, and communicating a compute task delegation request to the selected proximate device.

Implementations disclosed herein provide one or more physically manufactured computer-readable storage media, encoding computer-executable instructions for executing on a computer system a computer process, the computer process including determining that a compute task on a primary device is a resource-intensive AI task requiring one or more resources above a threshold, determining that the resource-intensive AI task can be delegated to one or more proximate computing devices, scanning one or more proximate devices to receive device advertisement packets, determining weighted scores for the one or more proximate devices based on the device advertisement packets, selecting one of the one or more proximate devices based on the weighted scores, and communicating a compute task delegation request to the selected proximate device.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store computer-executable computer program instructions that, when executed by a computer, cause the computer to perform methods and/or operations in accordance with the described implementations. The computer-executable computer program instructions may include any suitable type of code, such as source code, compiled code, interpreted code, executable code, static code, dynamic code, and the like. The computer-executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A method, comprising:
determining that a compute task on a primary device is a resource-intensive AI task requiring one or more resources above a threshold;
determining that the resource-intensive AI task can be delegated to one or more proximate computing devices;
scanning one or more proximate devices to receive device advertisement packets;
determining weighted scores for the one or more proximate devices based on the device advertisement packets;
selecting one of the one or more proximate devices based on the weighted scores; and
communicating a compute task delegation request to the selected proximate device.

2. The method of claim 1, wherein the resource-intensive AI task is an artificial intelligence (AI) task.

3. The method of claim 1, further comprising:
receiving an acknowledgement from the selected proximate device in response to the task delegation request; and
in response to receiving the acknowledgement, delegating the resource-intensive AI task to the selected proximate device.

4. The method of claim 1, wherein the device advertisement packets comprising one or more of device identifiers, device configuration specification, and device resource availability levels.

5. The method of claim 4, further comprising evaluating the device identifiers of a proximate device to determine that the proximate device is a trusted device.

6. The method of claim 4, further comprising:
evaluating the device identifiers of a proximate device of the one or more proximate devices to determine that the proximate device is not a trusted device; and
in response to determining that the proximate device is not a trusted device and that the proximate device belongs to a user network of the primary device, communicating a request to the proximate device to become one of a trusted device and a transiently trusted device.

7. The method of claim 4, wherein the device resource availability levels including one or more of a device power availability level, a device operations per second (OPS) level, and a cache availability level.

8. The method of claim 4, wherein the device advertisement packets received from the one or more proximate devices further comprising performance levels for previously executed tasks delegated to the one or more proximate devices.

9. The method of claim 1, wherein scanning one or more proximate devices further comprising scanning over at least one of a Bluetooth low energy (BLE) network, an ultra-wideband (UWB) network, and a wi-fi direct communication network.

10. A system, comprising:
memory;
one or more processor units; and
a compute task delegation system stored in the memory and executable by the one or more processor units, the compute task delegation system encoding computer-executable instructions on the memory for executing on the one or more processor units a computer process, the computer process comprising:
determining that a compute task on a primary device is a resource-intensive AI task requiring one or more resources above a threshold;
determining that the resource-intensive AI task can be delegated to one or more proximate computing devices;
scanning one or more proximate devices to receive device advertisement packets;
determining weighted scores for the one or more proximate devices based on the advertisement packets;
selecting one of the one or more proximate devices based on the weighted scores; and
delegating the resource-intensive AI task to the selected proximate device.

11. The system of claim 10, wherein the resource-intensive AI task is an artificial intelligence (AI) task.

12. The system of claim 10, wherein the device advertisement packets comprising one or more of device identifiers, device configuration specification, and device resource availability levels; and wherein the computer process further comprising:
evaluating the device identifiers of a proximate device to determine that the proximate device is not a trusted device; and
in response to determining that a proximate device is not a trusted device and that the proximate device belongs to a user network of the primary device, communicating a request to the proximate device to become one of a trusted device and a transiently trusted device.

13. The system of claim 10, wherein the device advertisement packets comprising one or more of device identifiers, device configuration specification, and device resource availability levels.

14. The system of claim 13, wherein the device resource availability levels including one or more of a device power availability level, a device operations per second (OPS) level, and a cache availability level.

15. The system of claim 13, wherein the device advertisement packets received from the one or more proximate devices further comprising performance levels for previously executed tasks delegated to the one or more proximate devices.

16. The system of claim 15, wherein determining weighted scores for the one or more proximate devices further comprising determining weighted scores for the one or more proximate devices based on the performance levels for previously executed tasks delegated to the one or more proximate devices.

17. One or more physically manufactured computer-readable storage media, encoding computer-executable instructions for executing on a computer system a computer process, the computer process comprising:
determining that a compute task on a primary device is a resource-intensive AI task requiring one or more resources above a threshold;
determining that the resource-intensive AI task can be delegated to one or more proximate computing devices;
scanning one or more proximate devices to receive device advertisement packets;
determining weighted scores for the one or more proximate devices based on the advertisement packets;
selecting one of the one or more proximate devices based on the weighted scores; and
delegating the resource-intensive AI task to the selected proximate device.

18. The one or more physically manufactured computer-readable storage media of claim 17, wherein the resource-intensive AI task is an artificial intelligence (AI) task.

19. The one or more physically manufactured computer-readable storage media of claim 17, wherein the device advertisement packets comprising one or more of device identifiers, device configuration specification, and device resource availability levels.

20. The one or more physically manufactured computer-readable storage media of claim 19, wherein the device resource availability levels including one or more of a device power availability level, a device operations per second (OPS) level, and a cache availability level.
